(19) United States
(12) Patent Application Publication
(10) Pub. No.: US 2012/0144117 A1
(43) Pub. Date: Jun. 7, 2012

(54) RECOMMENDATION BASED CACHING OF CONTENT ITEMS

(75) Inventors: Christopher B. Weare, Bellevue, WA (US); Eric N. Lockard, Sammamish, WA (US)

(73) Assignee: Microsoft Corporation, Redmond, WA (US)

(21) Appl. No.: 12/959,403

(22) Filed: Dec. 3, 2010

(51) Int. Cl. G06F 12/08

(52) U.S. Cl. 711/119; 711/E12.016; 711/118

(57) ABSTRACT

Content item recommendations are generated for users based on metadata associated with the content items and a history of content item usage associated with the users. Each content item recommendation identifies a user and a content item and includes a score that indicates how likely the user is to view the content item. Based on the content item recommendations, and constraints of one or more caches, the content items are selected for storage in one or more caches. The constraints may include users that are associated with each cache, the geographical location of each cache, the size of each cache, and/or costs associated with each cache such as bandwidth costs. The content items stored in a cache are recommended to users associated with the cache.

### BACKGROUND

Many existing systems recommend content items, such as music, films, and video games to users. These recommendation systems typically base their recommendations on a correlation of a history of content items viewed or used by a user and the histories of content items viewed or used by other users. Such systems may further use user submitted ratings or reviews and metadata describing various aspects of the content (genre, actors, appropriate age groups, etc.) provided by the content provider to further refine which content items are recommended to users.

While the recommendations generated by such systems are effective in alerting users to new or unknown content items, they are not currently used to make decisions as to the distribution or delivery of the recommended content items to users. Because of the decreasing cost of local storage and the tendency of users to access online content items at similar times (e.g., prime time), available local storage capacity and bandwidth may be wasted.

### SUMMARY

Content item recommendations are generated for users based on metadata associated with the content items and a history of content item usage associated with the users. Each content item recommendation identifies a user and a content item and includes a score that indicates how likely the user is to use or enjoy the content item. Based on the content item recommendations, and constraints of one or more caches, the content items are selected for storage in one or more caches. The constraints of the caches may include users that are associated with each cache, a geographical location of each cache, the size of each cache, and costs associated with each cache such as bandwidth costs, for example. The content items stored in a cache are recommended to users associated with the cache. By recommending content items that are stored in a cache associated with a user, overall bandwidth capacity may be better managed because content items may be distributed to the caches during off-peak times. In addition, a user experience may be improved because of low latency between a cache and the user.

In an implementation, metadata associated with content items is received by a computing device. User data associated with a user is received by the computing device. An affinity score is determined for each of the content items using the user data and the metadata associated with each of the content items. One or more of the content items are selected according to the determined affinity score. The selected content items are caused to be stored in a cache associated with the user by the computing device.

In an implementation, affinity data for each of a plurality of content items is received by a computing device. The affinity data for a content item includes an affinity score associated with each of a plurality of users. One or more constraints for each of a plurality of caches are received by the computing device. Each cache is associated with one or more of the users. For each cache, one or more of the content items are selected by the computing device based on the constraint(s) for the cache and the affinity scores associated with the users associated with the cache. For each cache, the selected content items are caused to be stored in the cache.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment for recommending content items and for storing content items in one or more caches according to the recommendations;

FIG. 2 is an illustration of an example content item recommender;

FIG. 3 is an operational flow of an implementation of a method for recommending one or more content items;

FIG. 4 is an operational flow of another implementation of a method for recommending one or more content items; and

FIG. 5 shows an exemplary computing environment in which example embodiments and aspects may be implemented.

### DETAILED DESCRIPTION

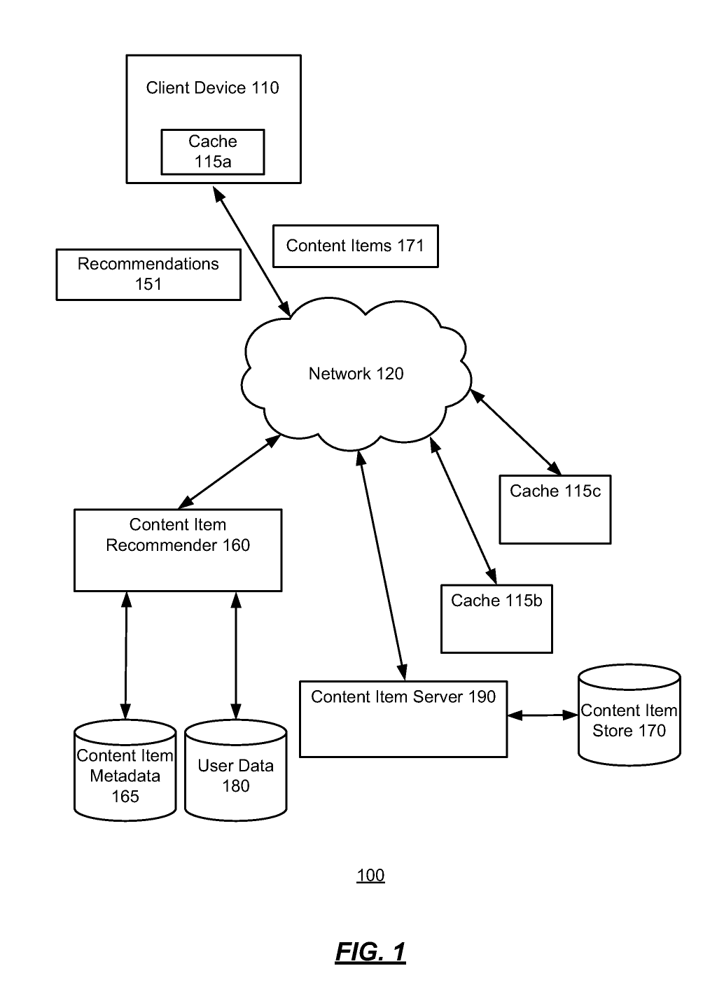

FIG. 1 is an illustration of an example environment 100 for recommending content items and for storing content items in one or more caches according to the recommendations. A client device 110 may communicate with a content item recommender 160 and content item server 190 through a network 120. The network 120 may be a variety of network types including the public switched telephone network (PSTN), a cellular telephone network, and a packet switched network (e.g., the Internet), for example.

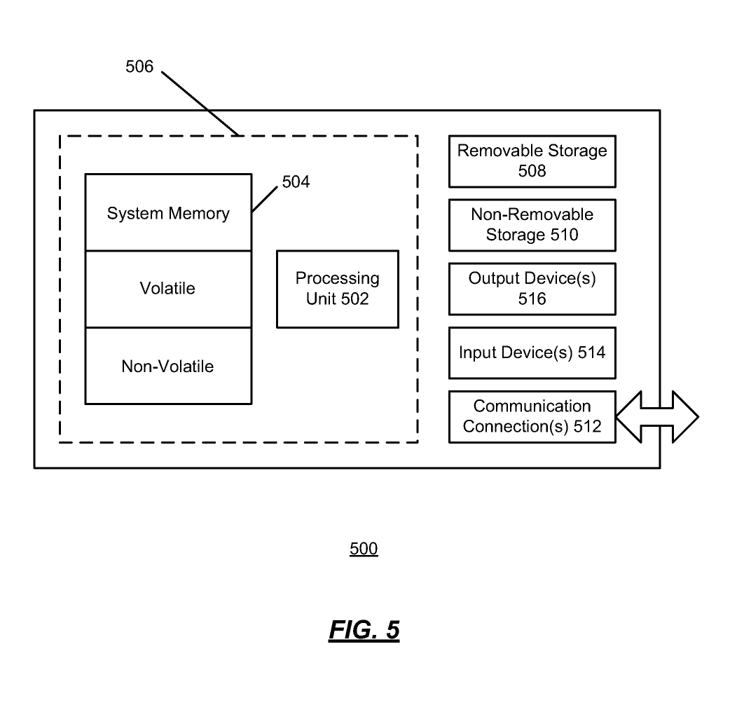

In some implementations, the client device 110 may include a desktop personal computer (PC), workstation, laptop, personal digital assistant (PDA), cell phone, smart phone, video game console, set-top box, television, or any other computing device capable of interfacing directly or indirectly with the network 120. The client device 110 may be implemented using a general purpose computing device such as the computing device 500 illustrated in FIG. 5, for example. While only one client device 110 is shown, it is for illustrative purposes only; there is no limit to the number of client devices 110 that may be supported by the environment 100.

The content item server 190 may provide one or more content items 171 to the client device 110 for usage by a user or users associated with the client device 110. The content items 171 may be stored and provided from a content item store 170 (or multiple content item stores) and may include video content items (e.g., movies, television shows, and videos), audio content items (e.g., songs, albums, and ringtones), computing device applications (e.g., cell phone application, personal computer applications, and related add-ons), and video game content items (e.g., video games, video game patches, and other video game related content such as downloadable levels, costumes, in game items, etc.), for example. Using a content item may include a variety of user actions such as downloading the content item, viewing the content item, listening to the content item, playing the content item, storing the content item, or sharing the content item, for example. The content item server 190 may be implemented using a general purpose computing device such as the computing device 500 illustrated in FIG. 5, for example.

The content item recommender 160 may generate one or more recommendations 151 for users and may send the recommendations 151 to one or more users at the client device 110 or multiple client devices through the network 120. In some implementations, the recommendations 151 may be recommendations of one or more content items 171 from the content item store 170 that the user may be interested in using. The recommendations 151 may be displayed or presented to users by their respective client device 110. The content item recommender 160 may be implemented using a general purpose computing device such as the computing device 500 illustrated in FIG. 5.

In some implementations, the content item recommender 160 may generate the recommendations 151 using user data 180. The user data 180 may include a usage history of content items 171 for one or more users. For example, the user data 180 may include a list of identifiers of some or all of the content items 171 that have been used by the user, such as the movies that the user viewed and/or the songs that the user has listened to.

The user data 180 may also include indicators of how satisfied the user was with each of the content items 171. For example, the user data 180 may include ratings that the user generated for the content items that they used. The user data 180 may also include other data such as demographic data about the users (e.g., age, income, sex, and nationality), social networking data associated with the user (e.g., “friends” associated with the user), and the type of client device 110 used by the user (e.g., cell phone, television, and video game console).

In some implementations, the content item recommender 160 may generate recommendations 151 using content item metadata 165 in addition to the user data 180. The content item metadata 165 may include metadata regarding some or all of the content items 171 from the content item store 170. For example, for a video content item, the content item metadata 165 may include information about the video content item such as a director, genre, or actors that appear in the video content item. For an audio content item, the content item metadata 165 may include artist information, album title, and genre, for example. Other information, such as an average rating or score associated with the content item and the number of times that the content item has been used, may also be part of the content item metadata 165.

In some implementations, the content item recommender 160 may generate recommendations 151 for a user by correlating the user data 180 of the user and other users, along with the content item metadata 165 associated with the content items 171. Any method or technique known in the art for recommending content items based on user data 180 and content item metadata 165 may be used.

The content item recommender 160 may use the generated recommendations 151 to determine one or more content items 171 to store in one or more caches 115a-115c. Each cache may be associated with one or more users or client devices. For example, the cache 115b may be associated with 100, 1000, or 10,000 users or client devices. Each user may be associated with one or more client devices and each client device may be associated with one or more users. There is no limit to the number of users or client devices that may be associated with a cache.

When a user of a client device 110 requests a content item, the content item server 190 and/or the content item recommender 160 may determine if the content item is stored in a cache associated with the requesting user and client device and if so, the content item request may be fulfilled from the cache rather than from the content item server 190. In general, a cache associated with a user and the user's client device is located closer to the user than the content item server 190, and therefore the cache may provide the user with reduced latency and increased performance when using a content item compared to the content item server 190. Thus, by fulfilling content item requests from the cache(s) (e.g., caches 115a-115c) when possible, the overall experience of users may be increased and the overall load on the content item server 190 may be reduced.

In some implementations, the caches 115a-115c may be associated with a particular geographic region such a country, state, or city. For example, the cache 115c may store content items for users in the San Francisco area, and the cache 115b may store content items for users in the New York area.

In addition, the caches 115a-115c may be associated with particular types of client devices. For example, the cache 115b may serve users of client devices that are smart phones, and the cache 115c may serve users of client devices that are video game consoles.

In some implementations, each client device 110 may have its own cache. For example, the cache 115a may be part of a client device 110 that is a set-top box or a video game console. The cache 115a may be implemented in a client device 110 using local storage such as a hard drive in the client device 110, for example.

In some implementations, the caches 115a-115c may be hierarchical. For example, when a client device 110 requests a content item, the client device 110 may first look for the content item in the cache 115a, and if the content item is not in the cache 115a, the client device 110 may look for the content item in the cache 115b.

As described further herein, the content item recommender 160 may cause one or more content items 171 to be stored in the caches 115a-115c based on the recommendations 151 and one or more characteristics of the caches 115a-115c. For example, the content item recommender 160 may generate recommendations 151 for a particular content item to users associated with the cache 115b. Accordingly, the content item recommender 160 may cause the content item server 190 to store the content items 171 associated with the recommendations 151 in the cache 115b.

In addition, the content item recommender 160 may provide recommendations 151 to users and client devices 110 associated with a cache that correspond to the content items 171 stored in the cache. Thus, the content item recommender 160 may cause the caches 115a-115c to be filled with content items 171 that correspond to recommendations 151, and also recommends the content items 171 that are subsequently stored in the caches 115a-115c. By filling a cache with content items 171 that the user is likely to be interested in, and recommending that the user use the content items 171 stored in their associated cache, the user is likely to use the content items 171 stored in their associated cache, leading to more efficient usage of the content item server 190 and a greater user experience due to reduced latency.

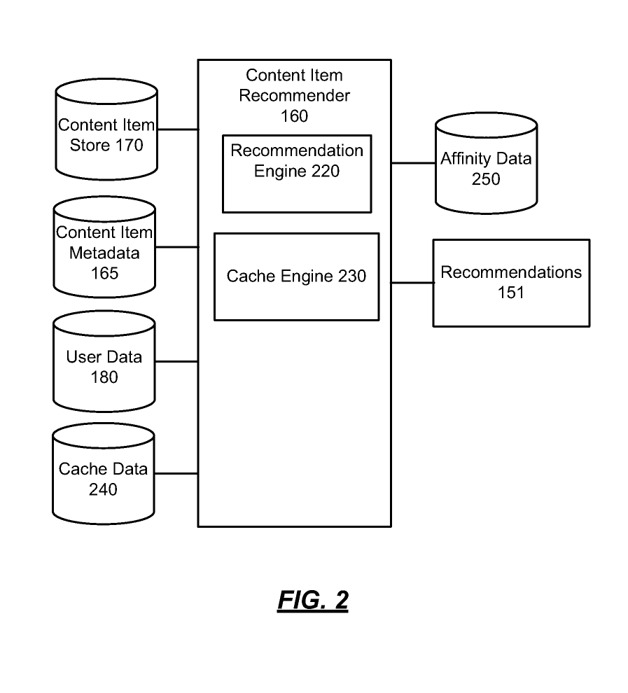

FIG. 2 is an illustration of an example content item recommender, such as the content item recommender 160. As shown, the content item recommender 160 may comprise components including, but not limited to, a recommendation engine 220 and a cache engine 230. While these components are illustrated as part of the content item recommender 160, each of the various components may be implemented separately from one another using one or more computing devices such as the computing device 500 illustrated in FIG. 5, for example.

The recommendation engine 220 may generate affinity data 250 for one or more content items 171 from the content item store 170. In some implementations, the affinity data 250 may include multiple tuples with each tuple including an identifier of a content item, an identifier of a user, and a generated affinity score for the identified user with respect to the identified content item. The affinity score may be a measure of the likelihood that the identified user will enjoy or use the identified content item. The affinity score for each tuple may be generated by the recommendation engine 220 for the identified content item from the user data 180 and the content item metadata 165. The affinity score may be generated using a variety of well known methods for predicting user interest in a content item including collaborative filtering, lift, and Bayesian inference. Other methods may be used.

The cache engine 230 may use the generated affinity data 250 to select one or more content items 171 to store in the caches 115a-115c. In some implementations, the cache engine 230 may select the content items 171 for a cache that have the greatest affinity scores. The number of content items 171 selected may be dependent on the size or space available in the cache. In other implementations, the cache engine 230 may select the content items 171 for a cache that have the greatest affinity scores for users associated with the cache. For example, if a single user is associated with the cache 115a because the cache 115a is located in a set-top box associated with the user, then the cache engine 230 may select one or more content items 171 that have a high affinity score for the user.

In some implementations, the cache engine 230 may select one or more content items 171 to store in the caches 115a-115c using the generated affinity data 250 and cache data 240 associated with each of the caches 115a-115c. The cache data 240 for a cache may describe one or more constraints or preferences associated with the cache, such as geographical restraints, size restrains, and bandwidth restraints. Other constraints may be used.

The geographical restraints may include a location of the cache and may include a geographical region of users that the cache may support. The size restraints may include the overall size of the cache and/or the amount of free space on the cache. The bandwidth constraints may include the bandwidth costs of the cache as well as constraints that describe the usage patterns of the users associated with the cache. For example, users associated with the cache 115b may infrequently or sporadically use content items 171, while users of the cache 115c may frequently use content items 171.

In some implementations, the cache engine 230 may, for each content item, generate a fitness score for each of the caches 115a-115c. The fitness score may be generated by the cache engine 230 using one or more fitness functions that take into account the affinity scores of the affinity data 250 for each content item, as well as one or more constraints from the cache data 240. For example, a particular fitness function used by the cache engine 230 may weigh the affinity scores of content items 171 as indicated by the affinity data 250 against the bandwidth costs associated with placing each content item in the cache and the usage patterns and geographical locations of the users associated with the cache as indicated by the cache data 240 when generating fitness scores for the content items 171 for a particular cache. Thus, a content item with a high affinity score for a user may receive a low fitness score for a cache if the user is located at a geographical location that is considered far from the cache, or if the user does not frequently view content items.

The cache engine 230 may select one or more content items 171 for storage in each cache according to the generated fitness scores for each of the content items 171 for the cache. In some implementations, the cache engine 230 may select the content items 171 for each cache having the greatest generated fitness scores for that cache.

The cache engine 230 may cause the selected one or more content items 171 to be stored in their respective caches. For example, the cache engine 230 may instruct the content item server 190 to send the selected one or more content items 171 to one of the caches 115a-115c.

The recommendation engine 220 may generate recommendations 151 for the content items 171 that were stored in the caches 115a-115c, and provide the generated recommendations 151 to the users. For example, the recommendations 151 may be emailed to the user, or displayed to the user in an application on the client device 110 such as a media player.

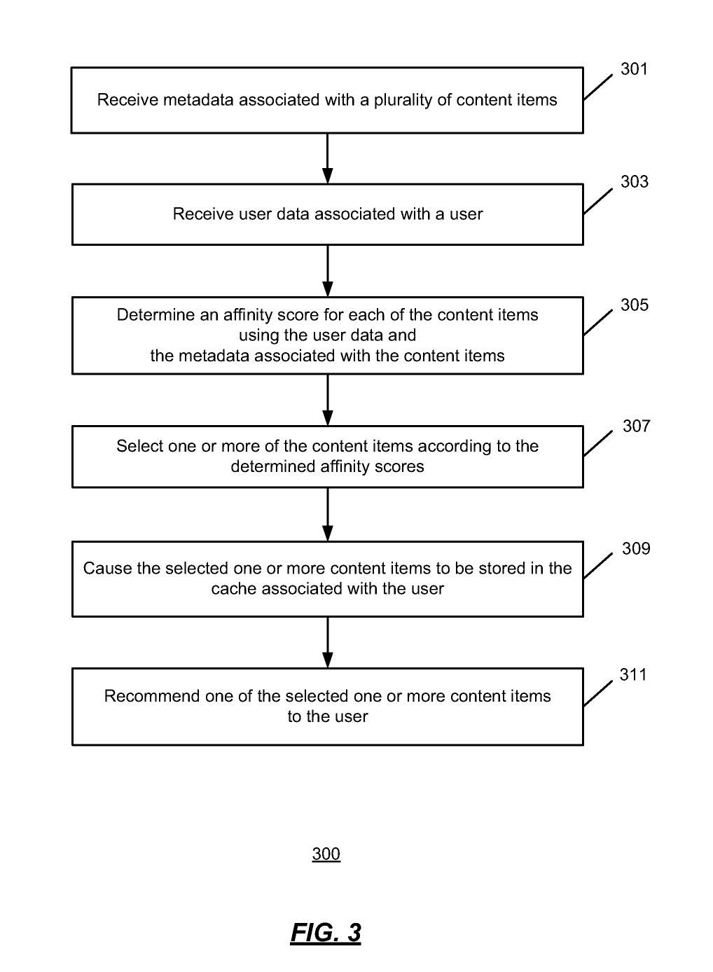

FIG. 3 is an operational flow of an implementation of a method 300 for recommending one or more content items. The method 300 may be implemented by the content item recommender 160, for example.

Metadata associated with a plurality of content items is received at 301. The metadata may comprise the content item metadata 165 and may be received by the content item recommender 160 from the content item server 190. In some implementations, the content items may include video content items, audio content items, and/or video game content items, for example. The metadata associated with each content item may include descriptive information such as a genre of the content item, a title of the content item, an author of the content item, an artist or creator associated with the content item, and other information, for example.

User data associated with a user is received at 303. The user data may comprise the user data 180 and may be received by the content item recommender 160 from the content item server 190. In some implementations, the user data 180 for a user may identify some or all of the content item history associated with the user. For example, the user data 180 may identify some or all of the video content items that were viewed by the user. In addition, the user data 180 may include known genre or artist preferences of the user, social networking data associated with the user, and one or more ratings for content items generated by the user, for example.

An affinity score for each of the content items is determined using the user data and the metadata associated with the content items at 305. The affinity score may be determined by the recommendation engine 220 of the content item recommender 160. In some implementations, an affinity score for a content item is a measure of the predicted likelihood that the user will use and/or enjoy the content item. The affinity score is determined using a variety of well known recommendation techniques using some or all of the metadata and the user data such as collaborative filtering, lift, and Bayesian inference. Other methods may be used.

One or more of the content items are selected according to the determined affinity scores at 307. The one or more content items are selected according to the determined affinity scores by the cache engine 230 of the content item recommender 160. In some implementations, a subset of the one or more content items with the highest overall affinity scores may be selected.

In some implementations, the one or more content items may be selected according to the affinity scores of the one or more content items and one or more constraints associated with the cache. The constraints may include the size or available space in the cache, a geographic location of the cache, and bandwidth costs associated with the cache and/or the client device 110 associated with the user, for example.

The selected one or more content items are caused to be stored in a cache associated with the user at 309. The selected one or more content items may be caused to be stored by the cache engine 230 of the content item recommender 160. For example, the content item recommender 160 may cause or instruct the content item server 190 to send the selected one or more content items from the content item store 170 to the cache associated with the user. In some implementations, the cache may be a local cache that is geographically located closer to the user than the content item server 190. Alternatively or additionally, the cache may be located in a client device 110 associated with the user.

One (or more) of the selected one or more content items is recommended to the user at 311. The selected content item(s) may be recommended to the user by the content item recommender 160. In some implementations, the content item recommender 160 may generate one or more recommendations 151 corresponding to the selected content item(s) and may provide them to the client device 110 associated with the user. The client device 110 may then display the recommendations 151 to the user.

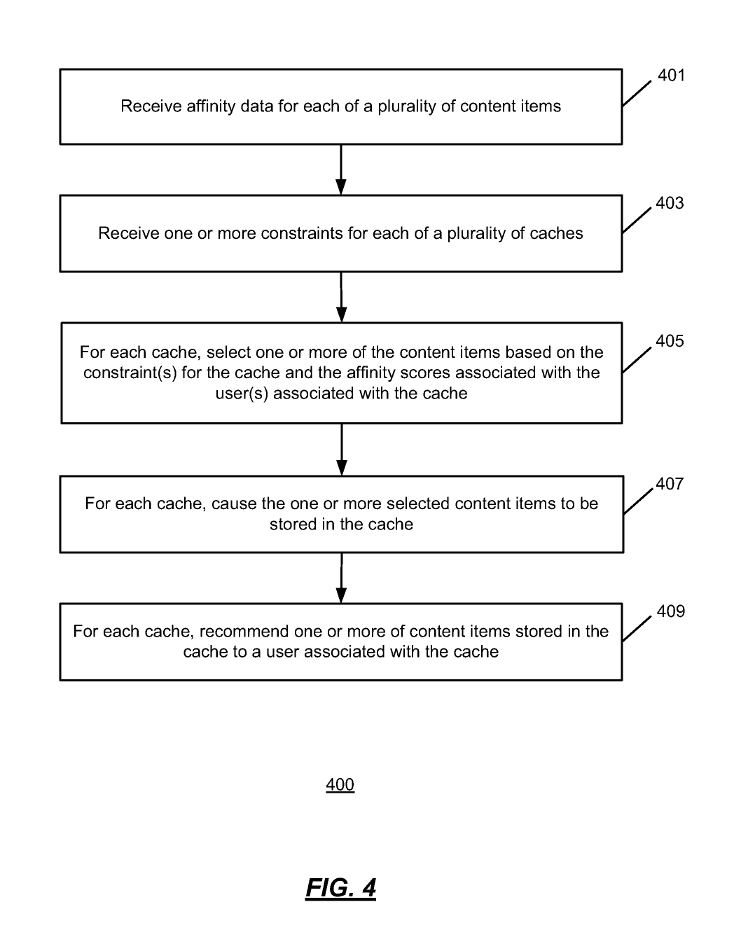

FIG. 4 is an operational flow of an implementation of a method 400 for recommending one or more content items. The method 400 may be implemented by the content item recommender 160, for example.

Affinity data is received for each of a plurality of content items at 401. The affinity data may be received by the cache engine 230 from the recommendation engine 220 of the content item recommender 160. In some implementations, the affinity data may comprise a set of tuples with each tuple including an identifier of a content item, an identifier of a user, and a determined affinity score. The affinity data may have been generated by the recommendation engine 220 using some or all of the user data 180 and the content item metadata 165.

One or more constraints are received for each of a plurality of caches at 403. The one or more constraints for each of the caches may be received by the cache engine 230 from the cache data 240. The one or more constraints for each of the caches may include the location of the cache, the latency or cost of bandwidth associated with the cache, and the size of the cache, for example.

For each cache, one or more content items are selected based on the one or more constraints for the cache and the affinity scores associated with the one or more users associated with the cache at 405. The content item(s) may be selected for each cache using a fitness function that scores each content item based on the affinity data associated with the content item and the one or more constraints associated with the cache by the cache engine 230 of the content item recommender 160. In some implementations, the one or more content items with the highest determined fitness scores are selected up to the size of the cache or available space in the cache. The fitness function may take into consideration the geographical location of the users and the cache so that affinity scores of users that are closer geographically to the cache are weighted higher than the affinity scores of users that farther away from the cache. Other constraints may be considered, such as the bandwidth costs associated with each user and the usage habits of the users associated with the cache.

For each cache, the one or more selected content items are caused to be stored in the cache at 407. The selected item(s) may be caused to be stored in each corresponding cache by the content item recommender 160. For example, the content item recommender 160 may instruct or cause the content item server 190 to store the selected content item(s) in a cache.

For each cache, one or more of the content items stored in the cache are recommended to a user associated with the cache at 409. The stored content item(s) may be recommended to the user by the content item recommender 160. In some implementations, the content item recommender 160 may generate one or more recommendations 151 corresponding to the stored content item(s) and may provide them to the client device 110 associated with the user. The client device 110 may display the recommendations 151 to the user.

FIG. 5 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by computing device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving metadata associated with a plurality of content items by a computing device;
receiving user data by the computing device;
determining an affinity score for each of the content items using the user data and the metadata associated with each of the content items by the computing device;
selecting one or more of the content items according to the determined affinity score; and
causing the selected one or more content items to be stored in a cache by the computing device.

2. The method of claim 1, wherein the cache is part of a media player, a video game console, a set-top box, or a television.

3. The method of claim 1, wherein the plurality of content items comprise audio content items, video content items, or video game content items.

4. The method of claim 1, wherein selecting one or more of the content items according to the determined affinity score further comprises receiving one or more constraints associated with the cache, and selecting one or more of the content items according to the determined affinity score and the received one or more constraints.

5. The method of claim 4, wherein the one or more constraints comprise geographical constraints and size constraints.

6. The method of claim 1, wherein the user data comprises a content item usage history associated with a user.

7. The method of claim 1, further comprising recommending one of the selected one or more content items to a user.

8. A method comprising:
receiving affinity data for each of a plurality of content items by a computing device, wherein the affinity data for a content item comprises an affinity score associated with one or more users of a plurality of users;
receiving one or more constraints for each of a plurality of caches by the computing device, wherein each cache is associated with one or more users of the plurality of users;
for each cache of the plurality of caches, selecting one or more of the plurality of content items based on the one or more constraints for the cache and the affinity scores associated with the one or more users of the plurality of users associated with the cache by the computing device; and
for each cache of the plurality of caches, causing the one or more selected content items to be stored in the cache by the computing device.

9. The method of claim 8, further comprising, for a cache of the plurality of caches, recommending one or more of the content items stored in the cache to a user associated with the cache.

10. The method of claim 8, wherein the one or more constraints include geographical restraints, bandwidth constraints, or size constraints.

11. The method of claim 8, wherein an affinity score associated with a user for a content item comprises a likelihood that the user will use the content item.

12. The method of claim 8, wherein the content items comprise video content items, audio content items, or video game content items.

13. The method of claim 8, wherein at least one cache of the plurality of caches is part of a computer, a media player, a video game console, a set-top box, or a television.

14. A system comprising:
at least one computing device; and
a content item recommender adapted to:
receive metadata associated with each of a plurality of content items;
receive user data associated with a user;
determine an affinity score for each of the plurality of content items using the user data and the metadata associated with each of the plurality of content items;
select one or more of the plurality of content items according to the determined affinity score; and
cause the selected one or more content items to be stored in a cache associated with the user.

15. The system of claim 14, wherein the content item recommender is further adapted to recommend one of the selected one or more content items to the user.

16. The system of claim 14, wherein the cache is part of a media player, a video game console, a set-top box, or a television associated with the user.

17. The system of claim 14, wherein the plurality of content items comprises audio content items, video content items, or video game content items.

18. The system of claim 14, wherein selecting one or more of the content items according to the determined affinity score further comprises receiving one or more constraints associated with the cache, and selecting one or more of the content items according to the determined affinity score and the received one or more constraints.

19. The system of claim 18, wherein the one or more constraints comprise geographical constraints and size constraints.

20. The system of claim 14, wherein the user data comprises a content item usage history associated with the user.
